(19) United States
(12) Patent Application Publication
(10) Pub. No.: US 2014/0127536 A1
(43) Pub. Date: May 8, 2014

(54) LITHIUM-ION BATTERY HAVING HIGH VOLTAGE

(71) Applicant: Joerg Kaiser, Eggenstein (DE)

(72) Inventor: Joerg Kaiser, Eggenstein (DE)

(73) Assignee: LI-TEC BATTERY GMBH, Kamenz (DE)

(21) Appl. No.: 14/111,373

(22) PCT Filed: Apr. 5, 2012
(86) PCT No.: PCT/EP2012/001535

§ 371 Date: Dec. 23, 2013

(30) Foreign Application Priority Data
Apr. 14, 2011 (DE) 102011017105.3

(51) Int. Cl. H01M 2/16

(52) U.S. Cl. CPC H01M 2/1666
USPC 429/50; 429/144

(57) ABSTRACT

The invention relates to a lithium ion battery comprising: (i) a positive electrode comprising at least a lithium transition metal phosphate having an olivine structure, wherein the transition metal selected is made of manganese, cobalt, nickel, or a mixture of two or three of said elements; (ii) a negative electrode; (iii) a separator that separates the positive and the negative electrode from one another and is permeable to lithium ions; wherein the separator comprises a mat made of non-woven, non-electrically conductive polymer fibres, which is coated with an ion-conducting inorganic material on one side or both sides; (iv) a non-aqueous electrolyte.

The entire content of the priority application DE 10 2011 017 105.3 is incorporated by reference into the present application.

The present invention relates to a secondary battery, particularly a lithium ion battery which has good stability even at high voltage output.

Secondary batteries, in particular lithium ion batteries, may be used to power mobile information devices because of their high energy density and high capacity. Moreover, such batteries are used in tools and for electrically powered cars and for automobiles used with hybrid drive. In order to make these batteries suitable for these uses, the batteries should display high voltage, high capacity and high durability with high security and reliability.

It is known to use lithium metal phosphate having an olivine structure as cathode material in lithium ion batteries, as these materials may have a high redox potential vis-à-vis lithium metal. For lithium manganese phosphate, a value of 4.1 V is known and for lithium cobalt phosphate a value of 5 V is known. However, it is also known that performance and safety of the battery may be impaired under the influence of high voltage. For example, the electrolyte in the battery and/or the separator may be adversely affected. This may lead to a failure of the battery, for example by way of short-circuiting reactions, and/or this may affect the safety of the battery otherwise.

One object of the present invention is to provide a secondary battery, particularly a lithium ion secondary battery, in which the separator used is as stable as possible, even at high voltages.

This and other task(s) is/are solved by a lithium-ion battery, comprising:
(i) a positive electrode comprising at least a lithium transition metal phosphate having olivine structure, in which the transition metal is selected from manganese, cobalt, nickel, or a mixture of two or three of these elements;
(ii) a negative electrode;
(iii) a separator that separates the positive and negative electrode from each other, and is permeable with respect to lithium ions, wherein the separator comprises a fleece of non-woven electrically non-conductive polymer fibers, which is coated on one side, or on both sides with an ion-conductive inorganic material;
(iv) a non-aqueous electrolyte.

### Battery

In the following, the terms “lithium ion battery” and “lithium ion secondary battery” are used interchangeably. These terms also include the terms “lithium battery”, “lithium ion battery” and “lithium-ion cell”. A lithium ion battery generally consists of a serial or parallel array of individual lithium ion cells. This means that the term “lithium ion battery” is used as a collective term for the above terms as commonly used in the art.

### Electrode

The term “positive electrode” relates to the electrode, which is capable of accepting electrons in case the battery is connected to a load, for example to an electric motor. Thus, the positive electrode represents the cathode

The term “negative electrode” relates to the electrode, which is capable of donating electrons. Thus, this electrode represents the cathode.

### Positive Electrode

In the lithium-ion battery in accordance with the present invention, a cathode material is used, which comprises a lithium transition metal having an olivine structure. Therein, in one embodiment, the phosphate has the formulas LiXPO₄, wherein X=Mn, Fe, Co or Ni, or combinations thereof.

Preferred lithium transition metal phosphates are lithium manganese phosphate, lithium cobalt phosphate and lithium nickel phosphate.

Particularly preferred are lithium manganese phosphate and lithium cobalt phosphate.

Lithium transition metal phosphates as such are known from the prior art and may be prepared by known methods, for example by sintering mixtures containing, as starting compounds, the corresponding oxides, or those which contain, as starting compounds, compounds that form the corresponding oxides during sintering.

The positive electrode may include mixtures of two or more of said substances.

The positive electrode preferably contains the lithium transition metal phosphate in the form of nanoparticles.

The nanoparticles may take any form, that is, they may be coarse-spherical or elongated.

In one embodiment, the lithium transition metal phosphate has a particle size, measured by the D95 value, of less than 15 μm. Preferably, the particle size is less than 10 μm.

In another embodiment, the lithium transition metal phosphate has a particle size, as measured by the D95-value, of between 0.005 μm to 10 μm. In another embodiment, the lithium transition metal phosphate has a particle size, as measured by the D95 value, of less than 10 μm, whereby the D50 value is 4 μm +/−2 μm and the D10 value is less than 1.5 μm.

These values given are determined by measurements using static laser light scattering (laser diffraction, laser diffractometry) as known from the prior art.

Further, it is also possible that the lithium-transition metal phosphate comprises carbon in order to increase the overall conductivity. Such compounds may be prepared by known methods, for example by coating with carbon compounds such as acrylic acid or ethylene glycol. Subsequently, the product is then pyrolyzed at a temperature of, for example, 2500° C.

### Negative Electrode

The negative electrode may be made from a variety of materials, which are known for use in a lithium-ion battery in the prior art. Basically, all materials may be used, which are able to form intercalation complexes with lithium.

For example, the negative electrode may include lithium metal or lithium in the form of an alloy, either in the form of a film, a grid or in the form of particles, which are held together by a suitable binder.

The use of lithium metal oxides, such as lithium-titanium oxide, is also possible.

Suitable materials for the negative electrode also include graphite, synthetic graphite, carbon black, mesocarbon, doped carbon, fullerenes. Niobium pentoxide, tin alloys, titanium dioxide, tin dioxide, silicon may also be used as electrode materials for the negative electrode.

The materials used for the positive and for the negative electrode are preferably held together by a binder, which holds these materials together, within the electrode. For example, polymeric binders may be used. For example polyvinylidene fluoride, polyethylene oxide, polyethylene, polypropylene, polytetrafluoroethylene, polyacrylate, ethylene (propylene diene monomer) copolymer (EPDM), and mixtures and copolymers thereof may be used as binders.

### Separator

The separator used for the battery must be permeable with respect to lithium ions in order to ensure the transport of ions, in particular of lithium ions, between the positive and the negative electrode. On the other hand, the separator must be insulating vis-à-vis electrons.

The separator comprises a fleece of non-woven polymeric fibers, which are not electrically conductive (“non-conductive”). Such fleeces are prepared, in particular, by spinning process and subsequent solidification.

The term “fleece” is used interchangeably with terms such as “nonwoven fabrics”, “knitted web” or “felt”. Instead of the term “non-woven”, also the term “un-woven” may be used.

Preferably, the polymer fibers are selected from the group of polymers consisting of polyacrylonitrile, polyolefin, polyester, polyimide, polyetherimide, polysulfone, polyamide, polyether. Suitable polyolefins include, for example, polyethylene, polypropylene, polytetrafluoroethylene, polyvinylidene fluoride.

Preferred polyesters include polyethylene terephthalate.

The fleece contained within the separator, according to the present invention, is preferably coated on one or on both sides with an ion-conductive inorganic material. The term “coating” also implies that the ion-conductive inorganic material may be located not only on one side or on both sides of the web, but also within the web/fleece.

The ion-conductive inorganic material preferably is ion-conductive in a temperature range of −40° C. to 200° C., in particular ion-conductive with respect to lithium ions. The material used for the coating is at least one compound selected from the group consisting of oxides, phosphates, sulfates, titanates, silicates, aluminosilicates of at least one of the elements zirconium, aluminum, silicon or lithium.

In a preferred embodiment, the ion-conductive material comprises or consists of aluminum oxide or zirconium oxide or aluminum oxide and zirconium oxide.

In one embodiment, a separator is used in the battery according to the invention, which consists of an at least partially permeable support, which is not or only poorly conducting vis-à-vis electrons. This support is coated, on at least one side, with an inorganic material. As at least partially permeable support material, an organic material may be used, which is configured as a nonwoven fleece. The organic material is realized in the form of polymer fibers, preferably polymeric fibers of polyethylene terephthalate (PET). The fleece is coated with an inorganic ion-conductive material, which is preferably ion-conductive in a temperature range of −40° C. to 200° C. The inorganic ion-conductive material preferably comprises at least one compound selected from the group consisting of oxides, phosphates, sulfates, titanates, silicates, aluminosilicates of at least one of the elements zirconium, aluminum, lithium, particularly preferably zirconium oxide. Preferably, said inorganic ion-conductive material comprises particles having a largest diameter of less than 100 nm.

Such a separator is distributed in Germany, for example, under the trade name “Separion®” by Evonik AG. Methods for producing such separators are known from the prior art, for example from EP 1 017 476 B1, WO 2004/021477 and WO 2004/021499.

In the following, particularly preferred embodiments of the separator used in the battery according to the invention, as well as advantages of the battery are summarized, in particular in regard to safety.

In principle, large pores and holes in separators as used in secondary batteries may lead to an internal short circuit. The battery may then discharge very quickly, even resulting in dangerous reactions. Thereby, such large electrical currents may occur, resulting in that a closed-cell battery, in the worst case, may even explode. For this reason the separator design contributes significantly to the safety or lack of safety of a lithium high-performance or high-energy lithium battery.

Polymer separators generally prevent current transport through the electrolyte, beginning at a certain temperature (the so-called “shut-down temperature”, which is typically at about 120° C.). This is achieved by the effect that, at this temperature, the pore structure of the separator collapses and all the pores are closed. Based on the fact that ions can no longer be transported, any dangerous reaction that may cause an explosion comes to a standstill. However, if the cell continues to heat up, e.g. due to external circumstances, the so-called “break-down” temperature is exceeded at about 150 to 180° C. Beginning at this temperature, conventional separators start to melt and to contract. In many parts of the battery cell, there is now a direct contact between the two electrodes, and thus an internal short circuit occurs over a large area. This leads to an uncontrolled reaction that may end with an explosion of the cell, or the resultant pressure must be vented through a pressure relief valve (rupture disk), often under fire.

In case of the present separator used in the inventive battery, comprising a fleece of non-woven polymeric fibers and an inorganic coating, shut-down (disconnection) may only occur, if, at high temperatures, the polymer structure of the substrate melts and penetrates the pores of the inorganic material and thereby closes the same. However, in the inventive separators, no breakdown occurs as the inorganic particles ensure that a complete melting of the separator cannot occur. This ensures that there are no operating conditions, in which a large-scale short-circuit may occur. Based on the nature of the nonwoven used, which provides a particularly suitable combination of thickness and porosity, separators can be prepared which meet the requirements for separators in high-capacity batteries, especially lithium batteries having high performance requirements. By the simultaneous use of oxide particle that are exactly matched in regard to their particle size for the production of porous (ceramic) coating, a particularly high porosity of the final separator is reached, wherein the pores are sufficiently small to prevent unwanted penetration of “lithium whiskers ” through the separator.

Based on the high porosity, in combination with the small thickness of the separator, it is also possible to impregnate the separator completely, or at least almost completely, with the electrolyte, so that no dead spaces occur in parts of the separator, i.e. spaces in certain windings or layers of the cells, in which no electrolyte exists. This is achieved, in particular, by the fact that the separators are free or substantially free of enclosed pores, into which the electrolyte cannot penetrate. This is achieved by means of observing the correct particle size of the oxide particles. The separators used in the invention also have the advantage that anions of the electrolyte salt at least partially attach to the inorganic surfaces of the separator, leading to an improvement in dissociation and thus to a better ionic conductivity in the high current range. Another considerable advantage of the separator is its superior wettability. Due to the hydrophilic ceramic coating, electrolyte wetting takes place very rapidly, which also leads to improved conductivity.

The separator used for the inventive battery, comprising a flexible fleece and having an inorganic coating disposed on and in said nonwoven fleece, wherein the material of the nonwoven fleece is selected from non-woven electrically non-conductive polymer fibers, is also characterized in that the nonwoven has a thickness of less than 30 μm, a porosity of more than 50%, preferably from 50 to 97%, and a pore radius distribution, in which at least 50% of the pores have a pore radius of from 75 to 150 μm.

More preferably, the separator comprises a nonwoven fleece having a thickness of 5 to 30 μm, preferably a thickness of 10 to 20 μm. Of particular importance is also a homogeneous pore radius distribution in the fleece, as specified above. A particularly homogeneous pore size distribution in the nonwoven, in conjunction with optimized particle sizes for the oxide particles, leads to an optimized porosity of the separator. The thickness of the substrate has a great influence on the properties of the separator, since, on the one hand, the flexibility but also, on the other hand, the area resistance of the electrolyte-saturated separator is dependent on the thickness of the substrate. Due to the small thickness, a particularly low electrical resistance of the separator is achieved, in use with an electrolyte. The separator itself has a very high electrical resistance, since the separator must have electrically insulating properties. Moreover, thinner separators allow an increased packing density in a battery stack, so a larger amount of energy may be stored in the same volume.

Preferably, the nonwoven has a porosity of 60 to 90%, particularly preferably from 70 to 90%. Therein, the porosity is defined as the volume of the fleece (100%) minus the volume of the fibers making up the fleece, i.e. that fraction of the volume of the nonwoven that is not filled by material.

Therein, the volume of the fleece can be calculated from the dimensions of the fleece. The volume of the fibers is calculated from the measured weight of the fleece and the density of the polymer fibers. The large porosity of the substrate allows for a higher porosity of the separator and therefore a higher uptake of electrolyte is achieved in regard to the separator. In order to obtain a separator having insulating properties, the separator comprises, as polymer fibers for the non-woven, preferably, electrically non-conductive fibers, i.e. polymers as defined above, which are preferably selected from polyacrylonitrile (PAN), polyesters, such as polyethylene terephthalate (PET) and/or polyolefins (PO), such as polypropylene (PP) or polyethylene (PE), or mixtures of such polyolefins.

The polymer fibers of the non-woven fleeces preferably have a diameter of 0.1 to 10 μm, preferably 1 to 4 μm.

Particularly preferred flexible fleeces have a basis weight of less than 20 g/m², preferably from 5 to 10 g/m².

Preferably, the web is flexible and has a thickness of less than 30 μm.

The separator comprises, in and on the non-woven, a porous electrically insulating ceramic coating. Preferably, this porous inorganic oxide particulate coating on and in the nonwoven comprises the elements Li, Al, Si and/or Zr having an average particle size of 0.5 to 7 μm, preferably 1 to 5 μm, and most preferably from 1.5 to 3 μm.

More preferably, the separator comprises a porous inorganic coating that is present in or the non-woven, which comprises alumina particles. These particles preferably have an average particle size of 0.5 to 7 μm, preferably 1 to 5 μm, and most preferably 1.5 to 3 μm. In one embodiment, the alumina particles are adhesively interconnected with an oxide of the elements Zr and Si.

In order to achieve a very high porosity, preferably more than 50 wt.-%, and particularly preferably more than 80 wt.-% of the particles lie within the above-mentioned limits for the average particle size. As described above, the maximum particle size is preferably ⅓ to ⅕ and more preferably less than or equal to 1/10 of the thickness of the nonwoven fleece used.

Preferably, the separator has a porosity of 30 to 80%, preferably from 40 to 75% and more preferably from 45 to 70%. Therein, the porosity is based on the accessible pores, i.e. on open pores. The porosity can be determined by the known method of mercury porosimetry or can be calculated from the volume and the density of the materials used, if it is assumed that only open pores are present. The separators used for the battery according to the invention are also distinguished by the fact that they may have a tensile strength of at least 1 N/cm, preferably at least 3 N/cm and most preferably from 3 to 10 N/cm. The separators can be bent, preferably without damage, to any radius down to 100 mm, preferably down to 50 mm and most preferably down to 1 mm.

The high tensile strength and the good flexibility (capability to be bent) of the separator have the advantage that any changes in the geometry of the electrodes potentially occurring during charging and discharging of a battery are tolerated without the separator being damaged. The flexibility also has the advantage that commercially standardized wound cells can be produced with this separator. In these cells, the electrode/separator layers are wound together, in a standard size spiral, and are contacted.

In one embodiment, it is possible to design the separator so that it has the shape of a concave or convex sponge or pad, or the form of wires or of a felt. This embodiment is well suited to compensate for volume changes in the battery. Corresponding methods of preparation are known in the art.

In a further embodiment, the polymer used in the nonwoven separator comprises a further polymer. Preferably, this additional polymer is arranged between the separator and the negative electrode and/or the separator and the positive electrode, preferably in the form of a polymer layer.

In one embodiment, the separator is coated with this polymer, on one side or on both sides.

Said polymer may be present in the form of a porous membrane, i.e. as a film, or in the form of a fleece, preferably in the form of a fleece of non-woven polymeric fibers.

These polymers are preferably selected from the group consisting of polyester, polyolefin, polyacrylonitrile, polycarbonate, polysulfone, polyethersulfone, polyvinylidene fluoride, polystyrene, polyetherimide.

Preferably, the additional polymer is a polyolefin. Preferred polyolefins are polyethylene and polypropylene.

Preferably, the separator is coated with one or more layers of an additional polymer, preferably polyolefin, which preferably are also present as a fleece, i.e. as non-woven polymer fibers.

Preferably, the separator comprises a nonwoven fleece of polyethylene terephthalate, which is coated with one or more layers of the additional polymer, preferably polyolefin, which preferably are also present as a fleece of nonwoven polymer fibers.

Particularly preferred is a separator of the type described above as “Separion”, which is coated with one or more layers of an additional polymer, preferably polyolefin, which preferably are also present as a fleece of non-woven polymer fibers.

The coating with the additional polymer, preferably with the polyolefin, may be achieved by gluing, lamination, by a chemical reaction, by welding or by a mechanical engagement. Such polymer composites and methods for their preparation are known from EP 1 852 926.

Preferably, the fiber diameter of the polyethylene terephthalate fleece is larger than the fiber diameter of the additional polymer fleece, preferably the polyolefin fleece, with which the separator is coated on one side, or on both sides.

Preferably, the fleece (non-woven) made of polyethylene terephthalate has a larger diameter than the pores of fleece (non-woven) that is made of the additional polymer.

Preferably, fleeces suitable for use in the separator are made of nanofibers of the polymers used, which results in fleeces that have a high porosity while forming pores having a small pore diameter. Thus, the risk of short-circuit reactions is further reduced.

The use of a polyolefin in addition to polyethylene terephthalate ensures increased safety of the electrochemical cell, since unwanted or excessive heating of the cell leads to a contracting of the pores of the polyolefin, whereby the charge transport through the separator is reduced or terminated. In case the temperature of the electrochemical cell increases further so that the polyolefin begins to melt, the polyethylene terephthalate counteracts the complete melting of the separator, i.e. effectively counteracts an uncontrolled degradation of the electrochemical cell.

The combination of a positive electrode comprising a lithium transition metal phosphate, in particular lithium manganese phosphate or lithium cobalt phosphate, with a separator comprising a fleece of non-woven polymeric fibers, which is coated on one side or on both sides with an ion conductive inorganic material, results in a battery that is extremely reliable in operation, which in the present case is of particular significance in respect to the high energy densities and voltages, which are the result of the choice of the cathode material used in the present invention. This combination is highly convenient for use as a power source for mobile information devices, for tools, for electrically powered cars and for cars with hybrid drive.

### Non-Aqueous Electrolyte

Suitable electrolytes for the battery according to the invention are known from the prior art. The electrolyte preferably comprises a liquid and a conductive salt. Preferably the liquid is a solvent for the electrolyte salt. Preferably, the electrolyte is present as an electrolyte solution.

Suitable solvents are preferably inert. Suitable solvents include, for example, solvents such as ethylene carbonate, propylene carbonate, butylene carbonate, dimethyl carbonate, diethyl carbonate, ethyl methyl carbonate, methyl propyl carbonate, butylmethyl carbonate, ethyl propyl carbonate, dipropyl carbonate, cyclopentanones, sulfolane, dimethyl sulfoxide, 3-methyl-1,3-oxazolidine-2-one, γ-butyrolacton, 1,2-diethoxymethane, tetrahydrofuran, 2-methyltetrahydrofuran, 1, 3-dioxolane, methyl acetate, ethyl acetate, nitromethane, 1,3-propanesultone.

In one embodiment, ionic liquids may also be used.

Ionic liquids are known in the prior art. They only contain ions. Examples of suitable cations, which can be alkylated in particular, are imidazolium, pyridinium, pyrrolidinium, guanidinium, uronium, thiuronium, piperidinium, sulfonium, ammonium and phosphonium cations. Examples of suitable anions are halide, tetrafluoroborate, trifluoroacetate, triflate, hexafluorophosphate, phosphinate and tosylate anions.

The following examples of ionic liquids may be mentioned: N-Methyl-N-propyl-piperidinium-bis(trifluoromethylsulfonyl) imide, N-methyl-N-butylpyrrolidinium-bis(trifluoromethylsulfonyl) imide, N-butyl-N-trimethyl-ammonium-bis (trifluoromethylsulfonyl) imide, triethylsulfonium-bis(trifluormethylsulfonyl) imide, N,N-diethyl-N-methyl-N-(2-methoxyethyl)-ammonium-bis(trifluormethylsulfonyl) imide.

Two or more of the above liquids may be used.

Preferred conducting salts are lithium salts having anions which are inert and which are are non-toxic.

Suitable lithium salts include lithium hexafluorophosphate, lithium hexafluoroarsenate, lithium bis(trifluoromethylsulfonyl imide), lithium trifluoromethansulfonate, lithium tris(trifluoromethylsulfonyl) methide, lithium tetrafluoroborate, lithium perchlorate, lithium tetrachloroaluminate, lithium chloride, lithium bisoxalatoborate, lithium difluoroxalatoborate, and mixtures of two or more of these salts.

### Manufacture of the Battery

The preparation of the novel lithium-ion battery can be preferably realized by means of depositing lithium transition metal phosphate as a powder onto the electrode and compressing the same into a thin film, optionally using a binder, in the step of preparing the positive electrode. The other electrode can be laminated onto the first electrode, wherein the separator is laminated in advance onto the negative or onto the positive electrode, in the form of a film. It is also possible to process the positive electrode, the separator and the negative electrode concurrently, mutually laminating the same.

In one embodiment, the positive electrode of the battery according to the invention comprises, as the lithium-transition metal phosphate, lithium manganese phosphate or lithium cobalt phosphate.

In one embodiment, the lithium manganese phosphate or lithium cobalt phosphate is coated with carbon.

In one embodiment, the separator comprises a fleece of non-woven polyethylene terephthalate fibers, which is coated, on both sides, with an ion-conducting inorganic material comprising alumina.

In one embodiment, the non-aqueous electrolyte is a liquid selected from ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, an ionic liquid, and mixtures of two or more of these liquids.

In one embodiment, the lithium salt is LiPF₆.

### Use

The inventive battery can be provided to operate at high voltage, high energy density and capacity, said battery having a good stability even at a high voltage output. Therefore, said battery can preferably be used for supplying power for mobile information devices, tools, electrically powered automobiles and for cars with hybrid drive.

1-17. (canceled)

18. A lithium-ion battery, comprising:
a positive electrode comprising a lithium transition metal phosphate having olivine structure, in which the transition metal comprises at least one element selected from the group consisting of: manganese, cobalt, and nickel;
a negative electrode;
a separator that separates the positive electrode and the negative electrode from each other, and is permeable with respect to lithium ions, wherein the separator comprises a fleece of non-woven electrically non-conductive polymer fibers, which is coated on one or both sides with an ion-conductive inorganic material; and
a non-aqueous electrolyte.

19. The lithium-ion battery according to claim 18, wherein the lithium transition metal phosphate is coated with carbon.

20. The lithium-ion battery according to claim 18, wherein the negative electrode comprises at least one material selected from the group consisting of: carbon, metallic lithium, lithium titanate, and silicon.

21. The lithium-ion battery according to claim 18, wherein the polymer fibers are comprised of at least one material selected from the group consisting of: polyacrylonitrile, polyolefin, polyester, polyimide, polyetherimide, polysulfone, polyamide, and polyether.

22. The lithium-ion battery according to claim 18, wherein the polymeric fibers comprise polyethylene terephthalate.

23. The lithium-ion battery according to claim 18, wherein said inorganic ion-conductive material is comprised of at least one compound selected from the group consisting of:
oxides, phosphates, sulfates, titanates, silicates, and aluminosilicates of at least one of the elements Zr, Al, Li.

24. The lithium-ion battery according to claim 18, wherein said inorganic ion-conductive material comprises at least one compound selected from the group consisting of:
alumina, zirconia, and silica.

25. The lithium-ion battery according to claim 18, wherein said inorganic ion-conductive material comprises particles having a maximum diameter of less than 100 nm.

26. The lithium-ion battery according to claim 18, wherein the electrolyte comprises a liquid having a lithium salt.

27. The lithium-ion battery according to claim 26, wherein said liquid is comprised of at least one liquid selected from the group consisting of: ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanones, sulfolane, dimethyl sulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate, nitromethane, 1,3-propanesultone, and an ionic liquid.

28. The lithium-ion battery according to claim 26, wherein the lithium salt is comprised of at least one salt selected from the group consisting of: LiPF₆, LiBF₄, LiCIO₄, LiAsF₆, L1CF₃SO₃, LiN(CF₃SO₂)₂, LiC(CF₃SO₂)₃, LiSO₃CₓF₂ₓ₊₁, LiN(SO₂CₓF₂ₓ₊₁)₂ LiC(SO₂CₓF₂ₓ₊₁)₃ with 0<x<8, Li[(C₂O₄)₂B], and Li[(C₂O₄)BF₂].

29. The lithium-ion battery according to claim 18, wherein the lithium transition metal phosphate is lithium manganese phosphate or lithium cobalt phosphate.

30. The lithium-ion battery according to claim 29, wherein the lithium transition metal phosphate comprises carbon.

31. The lithium-ion battery according to claim 30, wherein the separator comprises a fleece of non-woven polyethylene terephthalate fibers, which is/are coated on one side, or on both sides, with an ion-conducting inorganic material, which comprises aluminum oxide.

32. The lithium-ion battery according to claim 29, wherein the electrolyte comprises a liquid having a lithium salt, the liquid comprised of at least one liquid selected from the group consisting of: ethylene carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, and an ionic liquid.

33. The lithium-ion battery according to claim 29, wherein the electrolyte comprises a liquid having a lithium salt comprised of LiPF₆.

34. A method comprising:
using a lithium-ion battery according to claim 18 to supply power for at least one of: mobile information devices, tools, electrically powered automobiles and automobiles having a hybrid drive.
